(19) United States
(12) Patent Application Publication
(10) Pub. No.: US 2015/0242605 A1
(43) Pub. Date: Aug. 27, 2015

(54) CONTINUOUS AUTHENTICATION WITH A MOBILE DEVICE

(71) Applicant: QUALCOMM Incorporated, San Diego, CA (US)

(72) Inventors: Eliza Yingzi Du, Cupertino, CA (US); Suryaprakash Ganti, Los Altos, CA (US); Muhammed Ibrahim Sezan, Los Gatos, CA (US); Jonathan Charles Griffiths, Fremont, CA (US); David William Burns, San Jose, CA (US); Samir Gupta, San Diego, CA (US)

(21) Appl. No.: 14/523,689

(22) Filed: Oct. 24, 2014

Related U.S. Application Data
(60) Provisional application No. 61/943,428, filed on Feb. 23, 2014.
(60) Provisional application No. 61/943,435, filed on Feb. 23, 2014.

(51) Int. Cl. G06F 21/31

(52) U.S. Cl. CPC G06F 21/31

(57) ABSTRACT

A mobile device may perform continuous authentication with an authenticating entity. The mobile device may include a set of biometric and non-biometric sensors and a processor. The processor may be configured to receive sensor data from the set of sensors, form authentication information from the received sensor data, and continuously update the authentication information.

### CROSS REFERENCE TO RELATED APPLICATIONS

The present application claims priority to U.S. Provisional Patent Application No. 61/943,428, filed Feb. 23, 2014, entitled “Trust Broker for Authentication Interaction with Mobile Devices,” and U.S. Provisional Patent Application No. 61/943,435 filed Feb. 23, 2014, entitled “Continuous Authentication for Mobile Devices”, the content of which are hereby incorporated by reference in their entirety for all purposes. The present application also claims priority to Applicant's non-provisional patent application entitled “Trust Broker Authentication Method for Mobile Devices”, attorney docket number 143588, filed concurrently with the present application, the content of which is hereby incorporated by reference into the present application in its entirety for all purposes.

### FIELD

The present invention relates to continuous authentication of a user of a mobile device.

### RELEVANT BACKGROUND

Many service providers, services, applications or devices require authentication of users who may attempt to access services or applications remotely from, for example, a mobile device such as a smart phone, a tablet computer, a mobile health monitor, or other type of computing device. In some contexts, a service provider such as a bank, a credit card provider, a utility, a medical service provider, a vendor, a social network, a service, an application, or another participant may require verification that a user is indeed who the user claims to be. In some situations, a service provider may wish to authenticate the user when initially accessing a service or an application, such as with a username and password. In other situations, the service provider may require authentication immediately prior to executing a transaction or a transferal of information. The service provider may wish to authenticate the user several times during a session, yet the user may choose not to use the service if authentication requests are excessive. In some contexts, a device may require to authenticate a user. For example, an application such as a personal email application on a mobile device may require verification that a user is indeed the rightful owner of the account.

Similarly, the user may wish to validate a service provider, service, application, device or another participant before engaging in a communication, sharing information, or requesting a transaction. The user may desire verification more than once in a session, and wish some control and privacy before sharing or providing certain types of personal information. In some situations, either or both parties may desire to allow certain transactions or information to be shared with varying levels of authentication.

### SUMMARY

Aspects of the invention relate to a mobile device that may perform continuous authentication with an authenticating entity. The mobile device may include a set of biometric and non-biometric sensors and a processor. The processor may be configured to receive sensor data from the set of sensors, form authentication information from the received sensor data, and continuously update the authentication information.

### BRIEF DESCRIPTION OF THE DRAWINGS

FIG. 1 is a block diagram of a mobile device in which aspects of the invention may be practiced.

FIG. 2 is a diagram of a continuous authentication system that may perform authentication with an authenticating entity.

FIG. 3 is a diagram illustrating the dynamic nature of the trust coefficient in the continuous authentication methodology.

FIG. 4 is a diagram illustrating a wide variety of different inputs that may be inputted into the hardware of the mobile device to continuously update the trust coefficient.

FIG. 5 is a diagram illustrating that the mobile device may implement a system that provides a combination of biometrics and sensor data for continuous authentication.

FIG. 6 is a diagram illustrating the mobile device utilizing continuous authentication functionality.

FIG. 7 is a diagram illustrating the mobile device utilizing continuous authentication functionality.

FIG. 8 is a diagram illustrating a wide variety of authentication technologies that may be utilized.

FIG. 9 is a diagram illustrating a mobile device and an authenticating entity utilizing a trust broker that may interact with a continuous authentication manager and a continuous authentication engine.

FIG. 10 is a diagram illustrating a variety of different implementations of the trust broker.

FIG. 11 is a diagram illustrating privacy vectors (PVs) and trust vectors (TVs) between a mobile device and an authenticating entity.

FIG. 12 is a diagram illustrating privacy vector components and trust vector components.

FIG. 13A is a diagram illustrating operations of a trust vector (TV) component calculation block that may perform TV component calculations.

FIG. 13B is a diagram illustrating operations of a data mapping block.

FIG. 13C is a diagram illustrating operations of a data mapping block.

FIG. 13D is a diagram illustrating operations of a data normalization block.

FIG. 13E is a diagram illustrating operations of a calculation formula block.

FIG. 13F is a diagram illustrating operations of a calculation result mapping block and a graph of example scenarios.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the term “mobile device” refers to any form of programmable computer device including but not limited to laptop computers, tablet computers, smartphones, televisions, desktop computers, home appliances, cellular telephones, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, mobile health devices, smart wearable devices, or any computing device or data processing apparatus. An “authenticating entity” refers to a service provider, a service, an application, a device, a social network, another user or participant, or any entity that may request or require authentication of a mobile device or a user of a mobile device.

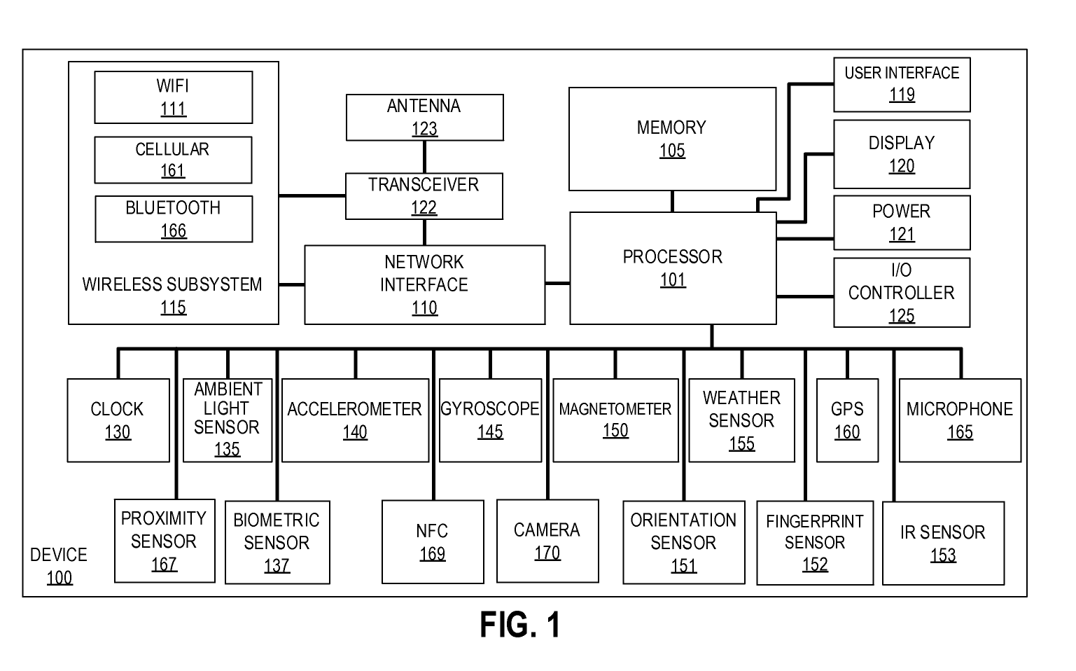

FIG. 1 is block diagram illustrating an exemplary device in which embodiments of the invention may be practiced. The system may be a computing device (e.g., a mobile device 100), which may include one or more processors 101, a memory 105, an I/O controller 125, and a network interface 110. Mobile device 100 may also include a number of sensors coupled to one or more buses or signal lines further coupled to the processor 101. It should be appreciated that mobile device 100 may also include a display 120 (e.g., a touch screen display), a user interface 119 (e.g., keyboard, touch screen, or similar devices), a power device 121 (e.g., a battery), as well as other components typically associated with electronic devices. In some embodiments, mobile device 100 may be a transportable device, however, it should be appreciated that device 100 may be any type of computing device that is mobile or non-mobile (e.g., fixed at a particular location).

Mobile device 100 may include a set of one or more biometric sensors and/or non-biometric sensors. Mobile device 100 may include sensors such as a clock 130, ambient light sensor (ALS) 135, biometric sensor 137 (e.g., heart rate monitor, electrocardiogram (ECG) sensor, blood pressure monitor, etc., which may include other sensors such as a fingerprint sensor, camera or microphone that may provide human identification information), accelerometer 140, gyroscope 145, magnetometer 150, orientation sensor 151, fingerprint sensor 152, weather sensor 155 (e.g., temperature, wind, humidity, barometric pressure, etc.), Global Positioning Sensor (GPS) 160, infrared (IR) sensor 153, proximity sensor 167, and near field communication (NFC) sensor 169. Further, sensors/devices may include a microphone (e.g. voice sensor) 165 and camera 170. Communication components may include a wireless subsystem 115 (e.g., Bluetooth 166, Wi-Fi 111, or cellular 161), which may also be considered sensors that are used to determine the location (e.g., position) of the device. In some embodiments, multiple cameras are integrated or accessible to the device. For example, a mobile device may have at least a front and rear mounted camera. The cameras may have still or video capturing capability. In some embodiments, other sensors may also have multiple installations or versions.

Memory 105 may be coupled to processor 101 to store instructions for execution by processor 101. In some embodiments, memory 105 is non-transitory. Memory 105 may also store one or more models, modules, or engines to implement embodiments described below that are implemented by processor 101. Memory 105 may also store data from integrated or external sensors.

Mobile device 100 may include one or more antenna(s) 123 and transceiver(s) 122. The transceiver 122 may be configured to communicate bidirectionally, via the antenna(s) and/or one or more wired or wireless links, with one or more networks, in cooperation with network interface 110 and wireless subsystem 115. Network interface 110 may be coupled to a number of wireless subsystems 115 (e.g., Bluetooth 166, Wi-Fi 111, cellular 161, or other networks) to transmit and receive data streams through a wireless link to/from a wireless network, or may be a wired interface for direct connection to networks (e.g., the Internet, Ethernet, or other wireless systems). Mobile device 100 may include one or more local area network transceivers connected to one or more antennas. The local area network transceiver comprises suitable devices, hardware, and/or software for communicating with and/or detecting signals to/from wireless access points (WAPs), and/or directly with other wireless devices within a network. In one aspect, the local area network transceiver may comprise a Wi-Fi (802.11x) communication system suitable for communicating with one or more wireless access points.

Mobile device 100 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 4G, or GSM. Additionally, any other type of wireless networking technologies may be used, for example, WiMax (802.16), Ultra Wide Band (UWB), ZigBee, wireless USB, etc. In conventional digital cellular networks, position location capability can be provided by various time and/or phase measurement techniques. For example, in CDMA networks, one position determination approach used is Advanced Forward Link Trilateration (AFLT).

Thus, device 100 may be a mobile device, wireless device, cellular phone, personal digital assistant, mobile computer, wearable device (e.g., head mounted display, wrist watch, virtual reality glasses, etc.), internet appliance, gaming console, digital video recorder, e-reader, robot navigation system, tablet, personal computer, laptop computer, tablet computer, or any type of device that has processing capabilities. As used herein, a mobile device may be any portable, movable device or machine that is configurable to acquire wireless signals transmitted from and transmit wireless signals to one or more wireless communication devices or networks. Thus, by way of example but not limitation, mobile device 100 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 100. Also, “mobile device” is intended to include all devices, including wireless communication devices, computers, laptops, etc., which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

It should be appreciated that embodiments of the invention as will be hereinafter described may be implemented through the execution of instructions, for example as stored in the memory 105 or other element, by processor 101 of mobile device 100 and/or other circuitry of device 100 and/or other devices. Particularly, circuitry of the device 100, including but not limited to processor 101, may operate under the control of a program, routine, or the execution of instructions to execute methods or processes in accordance with embodiments of the invention. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like. The functions of each unit or module within the mobile device 100 may also be implemented, in whole or in part, with instructions embodied in a memory, formatted to be executed by one or more general or application-specific processors.

Various terminologies will be described to aid in the understanding of aspects of the invention. Sensor inputs may refer to any input from any of the previously described sensors, e.g. a clock 130, ambient light sensor (ALS) 135, biometric sensor 137 (e.g., heart rate monitor, blood pressure monitor, etc.), accelerometer 140, gyroscope 145, magnetometer 150, orientation sensor 151, fingerprint sensor 152, weather sensor 155 (e.g., temperature, wind, humidity, barometric pressure, etc.), Global Positioning Sensor (GPS) 160, infrared (IR) sensor 153, microphone 165, proximity sensor 167, near field communication (NFC) sensor 169, or camera 170. In particular, some of the sensor inputs may be referred to as “biometric” sensor inputs or biometric sensor information from biometric sensors, which may include a biometric sensor 137 (e.g., heart rate inputs, blood pressure inputs, etc.), fingerprint sensor 152 (e.g., fingerprint input), touch screen 120 (e.g., finger scan or touch input), touch screen 120 (e.g., hand or finger geometry input), pressure or force sensors (e.g., hand or finger geometry), microphone 165 (e.g., voice scan), camera 170 (e.g., facial or iris scan), etc. It should be appreciated these are just examples of biometric sensor inputs and biometric sensors and that a wide variety of additional sensor inputs may be utilized. Further, other types of sensors may provide other types of inputs generally referred to herein as “non-biometric” sensor inputs/data or just sensor inputs/data (e.g., general sensors). One example of these generalized sensor inputs may be referred to as contextual inputs that provide data related to the current environment that the mobile device 100 is currently in. Therefore, a contextual sensor may be considered to be any type of sensor or combination of sensors that relate to the current context, condition or situation of the mobile device that may relate to contextual sensing information such as light, acceleration, orientation, weather, ambient pressure, ambient temperature, ambient light level, ambient light characteristics such as color constituency, location, proximity, ambient sounds, identifiable indoor and outdoor features, home or office location, activity level, activity type, presence of others, etc. Accordingly, examples of contextual sensors may include ambient light sensor 135, accelerometer 140, weather sensor 155, orientation sensor 151, GPS 160, proximity sensor 167, microphone 165, camera 170, etc. These merely being examples of contextual inputs and contextual sensors. In some implementations, biometric information and contextual information may be extracted from the same sensor such as a single camera or microphone. In some implementations, biometric information and contextual information may be extracted from the same set of sensor data. In some implementations, biometric and contextual information may be extracted from different sensors. In some implementations, biometric and contextual information may be extracted from different sensor data acquired from the same sensor or from a set of sensors. Additionally, data input may refer to user-inputted data for authentication (e.g., names, IDs, passwords, PINs, etc.) or any other data of interest for authentication. It should be noted that in some embodiments biometric sensor information may include raw sensor data or input from one or more biometric sensors, while in other embodiments the biometric sensor information may include only processed data such as fingerprint template information having positions and orientations of various minutiae associated with the fingerprint that allows subsequent recognition of the user yet does not allow recreation of the fingerprint image. In some embodiments, biometric sensor information may allow the authenticating entity to identify the user, while in other embodiments the matching or authentication is performed locally in a secure environment within the mobile device and only a verification output or an output of an authentication system such as an authentication level or an authentication score is provided to the authenticating entity. It should be noted that a sensor scan, such as a fingerprint, iris, voice or retina scan, does not imply a particular method or technique of acquiring sensor data, but rather is intended to more broadly cover any method or technique of acquiring sensor input. More generally, “sensor information” as used herein may include raw sensor data, processed sensor data, information or features retrieved, extracted or otherwise received from sensor data, information about the type or status of the sensor, aggregated sensor data, aggregated sensor information, or other type of sensor information. Similarly, “sensor data” may refer to raw sensor data, sensor input, sensor output, processed sensor data, or other sensor information.

Embodiments of the invention may relate to the determination of a dynamic (continuously time-varying) trust coefficient, or a trust vector as will be described later. The trust coefficient may convey the current level of authentication of a user of a mobile device 100 such as a smart phone, tablet, smart watch or other personal electronic device. For example, high levels of trust indicated by a high trust coefficient may be obtained by a high resolution fingerprint sensor 152 of mobile device 100 or by combining a user-inputted personal identification number (PIN) with the results from a simplified, less accurate sensor (e.g. a finger scan from a touch screen display 120). In another example, a high level of trust may be achieved with a high trust coefficient when a voice scan from microphone 165 or other soft biometric indicator is combined with a GPS location (e.g. from GPS 160) of a user (e.g. recognized user at office/home). In cases where an accurate biometric indicator is not available but a user has correctly answered a PIN, a moderate trust coefficient may be appropriate. In another example, the trust coefficient may simply convey the level or result of matching (e.g., a matching score or a result of matching) obtained from a fingerprint sensor. Examples of these scenarios will be hereinafter described in more detail.

Transactions made available to a user may be made to depend on the value of the trust coefficient. For example, a user with a high-level trust coefficient may be provided a high level of user access to sensitive information or more may be provided with the authority to execute financial transactions of greater value; a user with a medium-level trust coefficient may be provided with the authority to execute only small financial transactions; a user with a low-level trust coefficient may only be permitted browser access. A detected spoof attempt or other incorrect authentication result may incur a high mistrust value that requires high-level authentication to overcome.

In some embodiments, a trust coefficient may be calculated (e.g., via a method, function, algorithm, etc.). The trust coefficient may decay with time towards a lower level of trust or mistrust. As will be described, a mobile device and/or a server may determine the trust coefficient. As will be described, in some embodiments, a continuous authentication engine (CAE), a continuous authentication manager (CAM), and a trust broker (TB) may be configured to dynamically calculate, in real time, a trust coefficient so as to provide continuous or quasi-continuous authentication capability in mobile devices.

Embodiments of the invention may relate to an apparatus and method to perform authentication with an authenticating entity that the user wishes to authenticate with, based upon inputs from a plurality of sensors such as biometric sensors and non-biometric sensors, and/or user data input (e.g., user name, password, etc.). For example, the processor 101 of a mobile device 100 may be configured to: receive sensor data from the set of sensors, form authentication information from the received sensor data, and continuously update the authentication information to the authenticating entity. In particular, as will be described hereinafter, mobile device 100 under the control of processor 101 may implement this methodology to be hereinafter described.

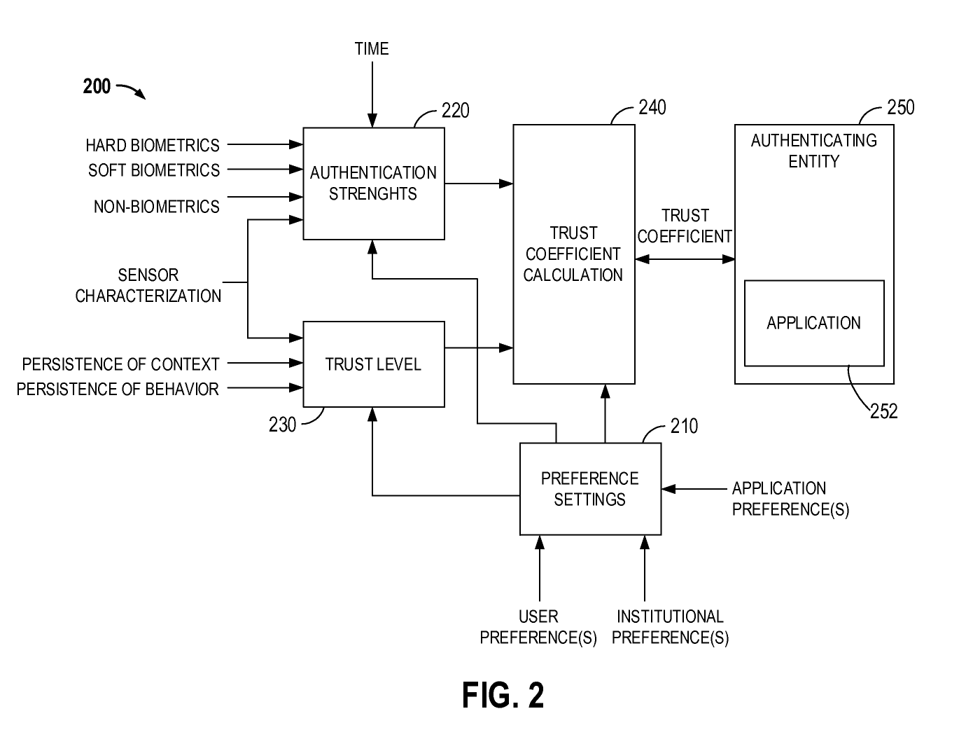

With additional reference to FIG. 2, a continuous authentication system 200 is shown that may be implemented by mobile device 100 to perform authentication with an authenticating entity 250. In particular, mobile device 100 may include a plurality of sensors such as biometric sensors and non-biometric sensors, as previously described. Further, mobile device 100, via processor 101, may be configured to implement a continuous authentication system 200 that includes a preference setting function block 210, an authentication strength function block 220, a trust level function block 230, and a trust coefficient calculation function block 240 to implement a plurality of functions.

These functions may include receiving an authentication request from an authenticating entity 250 (implementing an application 252) that may include a trust coefficient request or a request for other authentication information, based upon one or more of biometric sensor information, non-biometric sensor data, user data input, or time. Some sensor information may be determined on a continuous basis from data sensed continuously. For example, authentication strength function block 220 may retrieve, extract or otherwise receive biometric sensor information from biometric sensors (e.g. hard biometrics and/or soft biometrics), non-biometric sensor data from non-biometric sensors (e.g. non-biometrics), user data input, or other authentication information, which matches, fulfills, satisfies or is consistent with or otherwise incorporates predefined security/privacy preference settings (as determined by preference setting function block 210) in order to form a trust coefficient that is calculated by trust coefficient calculation function block 240. The trust coefficient may be continuously, quasi-continuously or periodically updated within the mobile device 100. The trust coefficient or other authentication information may be transmitted to the authenticating entity 250 for authentication with the authenticating entity in a continuous, quasi-continuous or periodical manner, or transmitted upon request or discreetly in time as required by the authenticating entity, e.g., for a purchase transaction. In some implementations, the authentication information may be sent to the authenticating entity 250 based on an interval or elapsing of time, or upon a change in the sensor data or authentication information from the set of sensors. In some implementations, the mobile device 100 may provide continuous authentication by calculating the trust coefficient or other authentication information with or without continuously receiving sensor information. In some implementations, continuous authentication may be provided on-demand by calculating the trust coefficient or other authentication information with or without accessing sensor information.

In one embodiment, the predefined security and privacy preference settings, as set by preference setting function block 210, may be defined by the authenticating entity 250, the mobile device 100, or by the user of the mobile device. The predefined security and privacy preference settings may include types of biometric sensor information, non-biometric sensor data, user data input, or other authentication information to be utilized or not utilized in determining the trust coefficient. Also, the predefined security/privacy preference settings may include required authentication strengths for biometric sensor information and/or non-biometric sensor data in order to determine whether they are to be utilized or not to be utilized. The authentication strength function block 220 may be configured to implement an authentication strength function to determine the authentication strength for a requested hard biometric data input, soft biometric data input, non-biometric data input, sensor data or other authentication information from the corresponding sensor(s) and to pass that authentication strength to the trust coefficient calculation function block 240, which calculates the trust coefficient that may be continuously or non-continuously transmitted to the authenticating entity 250.

For example, an authenticating entity 250 having associated applications 252 may implement such services as bank functions, credit card functions, utility functions, medical service provider functions, vendor functions, social network functions, requests from other users, etc. These types of authenticating entities may require some sort of verification. Embodiments of the invention may be related to continuously updating and transmitting a trust coefficient to an authenticating entity to provide continuous or quasi-continuous authentication.

As examples of various terms, a trust coefficient (TC) may be a level of trust based upon a data input, such as user data inputs (e.g., username, password, etc.), non-biometric sensor inputs (e.g., GPS location, acceleration, orientation, etc.), biometric sensor inputs (e.g., fingerprint scan from a fingerprint sensor, facial or iris scan from a camera, voiceprint, etc.). A trust coefficient may be a composition, aggregation or fusion of one or more data inputs. Also, as will be described, each of these inputs may be given an authentication strength and/or score by authentication strength function block 220 that are used in preparing one or more trust coefficient values by trust coefficient calculation function block 240. An authenticating entity 250 may set a risk coefficient (RC) that needs to be met to create, generate or otherwise form a trust level significant enough to allow for authentication of a mobile device 100 for the particular function to be performed. Therefore, authenticating entity 250 may determine whether mobile device 100 has generated a trust coefficient that is greater than the risk coefficient such that the authenticating entity 250 may authenticate the mobile device 100 for the particular function to be performed. The term trust coefficient may be a part of the trust vector (TV), as will be described in more detail later.

Looking more particularly at the functionality of FIG. 2, continuous authentication system 200 provides a method for continuous authentication. In particular, block 210 implements a security/privacy preference setting function to establish and maintain preference settings for execution. Preference settings as implemented by preference setting function block 210 may include user preferences, institutional preferences, or application preferences. For example, the preference settings may be related to security/privacy settings, security/privacy preferences, authentication strengths, trust levels, authentication methods, decay rate as a function of time, decay periods, preferred trust and credential input/output formats, ranges of scores and coefficients, persistence values, etc. User preferences may include, for example settings associated with access to different networks (e.g., home network, office network, public network, etc.), geographic locations (e.g., home, office, or non-trusted locations), operational environment conditions, and format settings. In some implementations, user preferences may include customizing the functionality itself, for example, modifying the trust coefficient decay rate as a function of time, changing the decay period, etc.

Institutional preferences may relate to the preferences of an institution, such as a trust broker of a third party service provider (e.g., of the authenticating entity 250), or other party that may wish to impose preferences, such as a wireless carrier, a device manufacturer, the user's employer, etc. Application preferences (e.g., from applications 252 of authenticating entities 250) may relate to the preferences imposed by the application or service that the user wishes to authenticate with, such as a website that the user desires to conduct financial transactions with, submit or receive confidential information to and from, make a purchase from, engage in social networking, etc. For example, the application preferences may include authentication level requirements and trust level requirements.

Accordingly, preference setting function block 210 may receive as inputs one or more specified preferences of the user, specified preferences from one or more applications or services from the authenticating entity that the user may wish to interact with, or specified preferences of third party institutions.

In one embodiment, preference setting function block 210 may implement a negotiation function or an arbitration function to negotiate or arbitrate conflicting predefined security and privacy preferences settings between the authenticating entity 250 (e.g., application preferences and institutional preferences) and the mobile device 100 (e.g., user preferences), or to create, generate or otherwise form fused security and privacy preference settings, which may be transmitted to the authentication strength function block 220, trust level function block 230, and the trust coefficient calculation function block 240. Thus, preference setting function block 210, which receives various user preferences, institutional preferences and application preferences, may be configured to output fused security/privacy preference settings to negotiate or arbitrate contradictory settings among the mobile device preferences, user preferences, application preferences, institutional preferences, etc. For example, a user of the mobile device 100 may set voice to be the most preferred authentication method for convenience. While an authenticating entity 250 such as a bank may set voice to be a least preferred authentication method due to suspected unreliability. Preference setting function block 210 may implement an arbitration or negotiation function to arbitrate or negotiate between any conflicting predefined security/privacy preference settings, and may output appropriate fused preference settings to the authentication strength function block 220 and trust coefficient calculation function block 240 (e.g., voice from the microphone and iris scan from the camera).

Authentication strength function block 220 may be configured to implement an authentication strength function to determine authentication strength based on, for example, hard biometric, soft biometric or non-biometric information input. As an example, biometric data may be defined into two categories: “hard” biometrics, which may include data for fingerprint recognition, face recognition, iris recognition, etc., and “soft” biometrics that may include clothes color and style, hair color and style, eye movement, heart rate, a signature or a salient feature extracted from an ECG waveform, gait, activity level, etc. Non-biometric authentication data may include a username, password, PIN, ID card, GPS location, proximity, weather, as well as any of previously described contextual sensor inputs or general sensor inputs. In addition, authentication strength function block 220 may receive sensor characterization data, including, for example, a sensor identification number, sensor fault tolerance, sensor operation environment and conditions that may impact the accuracy of the sensor, etc. Some biometrics information and sensor characterization data may change dynamically and continuously.

In one embodiment, authentication strength function block 220 may receive data inputs (hard biometrics, soft biometrics, non-biometrics, etc.) from these various biometric and non-biometric sensors and preference data from preference setting function block 210. Based upon this, authentication strength function block 220 may be configured to output a first metric to the trust coefficient calculation block 240 signifying the strength of the biometric or non-biometric sensor data to be used for user authentication. The first metric may be expressed using characterizations such as high, medium, low, or none; a number/percentage; a vector; other suitable formats; etc. The value of this metric may change dynamically or continuously in time as some biometrics information and sensor characterization data or preference settings may change dynamically and continuously.

The strength or reliability of soft and hard biometrics may be dynamic. For example, the user may be requested to enroll her biometric information (e.g., a fingerprint) or authenticate her after a certain amount of time following the first enrollment of the biometric information. It may be beneficial to shorten this time interval when/if suspicious use of the mobile could be detected. Similarly, for the sake of a user's convenience, the time interval could be lengthened when/if device autonomously recognizes, on a continuous basis, cues, e.g., consistent patterns of usage and context, to offset the passage of time and delay the need for re-authentication. Trust level function block 230 may implement a trust level function to analyze persistency over time to determine a trust level. In particular, trust level function block 230 may be configured to analyze the persistency over time of selected user behaviors or contexts and other authentication information. For example, trust level function block 230 may identify and/or analyze behavior consistencies or behavior patterns. Examples of behavior consistencies may include regular walks on weekend mornings, persistency of phone numbers called or texted to and from regularly, network behavior, use patterns of certain applications on the mobile device, operating environments, operating condition patterns, etc. Further, trust level function block 230 may identify and/or analyze other contextual patterns such as persistence of geographical locations, repeated patterns of presence at certain locations at regular times (e.g., at work, home, or a coffee shop), persistence of pattern of network access-settings (e.g., home, office, public networks), operating environment patterns, operating condition patterns, etc. Additionally, trust level function block 230 may receive sensor related characterization data, such as a sensor ID, sensor fault tolerance, sensor operation environment and conditions, etc.

Accordingly, trust level function block 230 may receive as inputs persistency of context and behavior and sensor characterization data. Trust level function block 230 may be configured to output a second metric to the trust coefficient calculation function block 240 indicating a level of trust. The second metric may be expressed using characterizations such as high, medium, low, or none; a number or percentage; components of vector; or other formats. The value of this metric may change dynamically or continuously in time when persistence of context, behavioral patterns, sensor characterization data, or preference settings change.

Further, trust coefficient calculation function block 240 may implement a trust coefficient calculation function to determine the trust coefficient based upon the authentication strength of the received input data from the biometric and non-biometric sensors and the trust level received based on the input data from the biometric and non-biometric sensors. Trust coefficient calculation function block 240 may be configured to receive the first metric of authentication strength from authentication strength function block 220, a second metric of trust level from trust level function block 230, preference settings from preference setting function block 210, as well as time/date input, to determine the trust coefficient. Trust coefficient calculation function block 240 may be configured to continuously or quasi-continuously, or discreetly and on demand, output a trust coefficient to authenticating entity 250 in order to provide continuous, quasi-continuous or discrete authentication with authenticating entity 250.

In some embodiments, as will be described in more detail hereinafter, trust coefficient calculation function block 240 may perform processes such as data interpretation and mapping based on a preset look-up table to map the input data and data format into a unified format; data normalization into a predetermined data range; calculations based on a method/formula that may be in accordance with a default or that may be changed based on preference setting changes requested over time by one or more requestors; mapping the calculation results and preferred formats in accordance with preference settings; etc.

Further, in some embodiments, as will be described in more detail hereinafter, the trust coefficient may include composite trust coefficients or trust scores having one or more components. The trust coefficients, scores or levels may be configured as part of a multi-field trust vector. Further, in some embodiments, trust coefficient calculation function block 240 may be configured to output trust coefficient components and include the credentials or other information used to authenticate the user or the device, or to provide other data used to complete a transaction (e.g., data verifying the user is not a computer or robot). In other implementations, trust coefficient calculation function block 240 may output a trust coefficient that is utilized by another system element, such as a trust broker, to release credentials or provide other data used to complete a transaction.

Based on the preference settings, the output format can be defined or changed. The trust coefficient components may change from one time to another due to preference setting changes. The trust coefficient components may change from one request to another due to differences between preference settings and different requestors. For example, an application preference or an institutional preference may be used to provide parameters to formulas that may configure or control the generation of trust coefficient components to meet specific requirements, such as required for the use of particular authentication methods or for altering the time constants of trust coefficient decay.

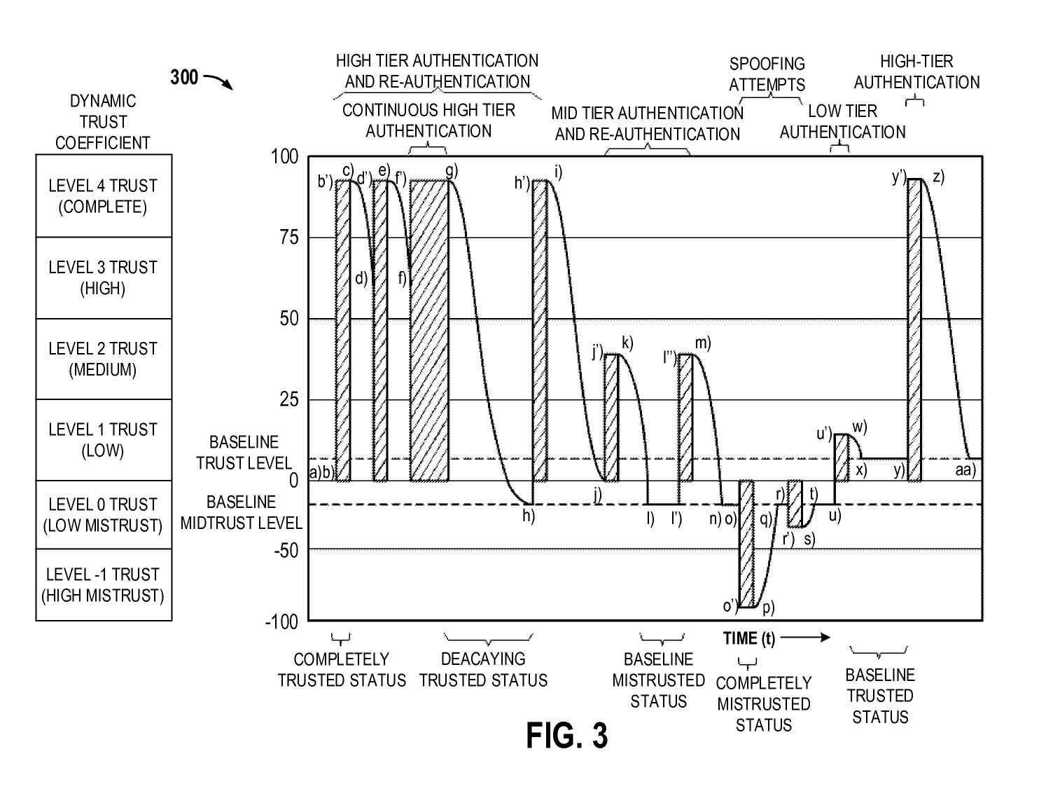

It should be appreciated that the output of trust coefficient calculation function block 240 may change in various manners in time as a user interacts in various ways with the mobile device 100. An example will be provided hereinafter, illustrating the dynamic nature of trust coefficients and continuous authentication with reference FIG. 3. FIG. 3 illustrates the dynamic nature of the trust coefficient in the continuous authentication methodology. For example, the y-axis illustrates a dynamic trust coefficient with various levels (e.g., level 4—complete trust; level 3—high trust; level 2—medium trust; level 1—low trust; level 0—mistrust; and level −1—high mistrust) and the x-axis represents time.

For example, at point a) the mobile device may begin an authentication process with a non-initialized status and a trust coefficient level of zero (identified at the border between level 1 low trust and level 0 low mistrust). At point b), the mobile device begins high-level authentication. For example, at point b′), high-level authentication has been achieved (e.g., with a fingerprint scan from a fingerprint sensor and a user ID and password). At this point b′), a completely trusted status has been acquired (e.g. level 4 complete trust). However, as shown at point c), the trust level begins to decline as time progresses. At point d), re-authentication of the trust coefficient is needed as the trust level has decreased down to level 3 trust. At this point, another input may be needed such as an eye scan via a camera. Based upon this, at point d′), the completely trusted status has been re-acquired.

Again, at point e), as time proceeds, the trust level again decays. Then, at point f), re-authentication is needed to bring the trust coefficient back to level 4 complete trust. At point f′), the completely trusted status has been reacquired based upon an additional sensor input. For example, a previous sensor input may be re-inputted (e.g., an additional fingerprint scan) or a new input may be acquired such as a voice scan through a microphone, which again brings the trust coefficient back to a complete level of trust. As previously described, the previous authentication has brought the dynamic trust coefficient back and forth to the level of complete trust.

However, at point g), the trust level begins to decay significantly all the way to point h), to where the dynamic trust coefficient has completely fallen out of trusted status to a level zero trust level (low mistrust) and re-authentication needs to reoccur. At point h′), a completely trusted status has been re-acquired. For example, the user may have inputted a fingerprint scan via a fingerprint sensor as well as a user ID and password. However again, at point i), as time increase the trust level may begin to decay back to point j), a low trust level.

At this point, request for service provider access may only need a medium trust level (e.g. level two), so at point j′), a medium trust level is acquired, such as, by just a low-resolution touch-screen finger sensor input. Again at point k), as time progresses the dynamic trust coefficient trust level declines all the way back to a level zero low mistrust (point 1) where the trust coefficient is maintained at a baseline level of mistrust. At point 1′), medium level authentication begins and at point 1″) medium level trusted status is re-acquired (e.g. by a touch-screen finger scan). However, at point m), the trust level begins to decay as time proceeds down to the baseline low mistrust level at point n). An attempted spoofing attack may be detected at point o). At point o′) the spoofing has failed and a completely mistrusted status has occurred (e.g. level −1 high mistrust), where it is retained for a time until point p).

With time, the high level of mistrust diminishes back to a baseline mistrust level. At point q), the decay is stopped at the baseline mistrusted status. At point r), medium level authentication begins again. At point r′), the medium level authentication has failed and a low mistrusted status level has been acquired (e.g. level 0). For example, the finger scan via the touch-screen may have failed. At this point, the trust level is retained for a time, then begins to decay at point s) back to the baseline level of mistrust at point t). At point t), the trust level is retained at a low level of mistrust until point u). A low level of authentication may begin at point u). For example, a low level authentication such as a GPS location may be acquired at point u′) such that there is at least a low level of trust until a point w). However, yet again, as time increases, the level of the dynamic trust coefficient begins to decline to point x), a low level trust, however, the decline may be stopped at point x′) (at a baseline low-level trusted status).

The process may begin again with requesting a high level of authentication, such as a fingerprint scan via a fingerprint sensor or a username and password, such that, at point y′), a completely trusted status is again acquired and the dynamic trust coefficient has been significantly increased. However, yet again, as time increases past a point z), the trust level again begins to decay to a baseline low-level trusted status at point aa).

It should be appreciated that, according to various implementations, the trust coefficient is dynamic and as the trust coefficient decreases with time, the user/mobile device may need to re-authenticate itself to keep the trust coefficient at a high enough level to perform operations with various authenticating entities.

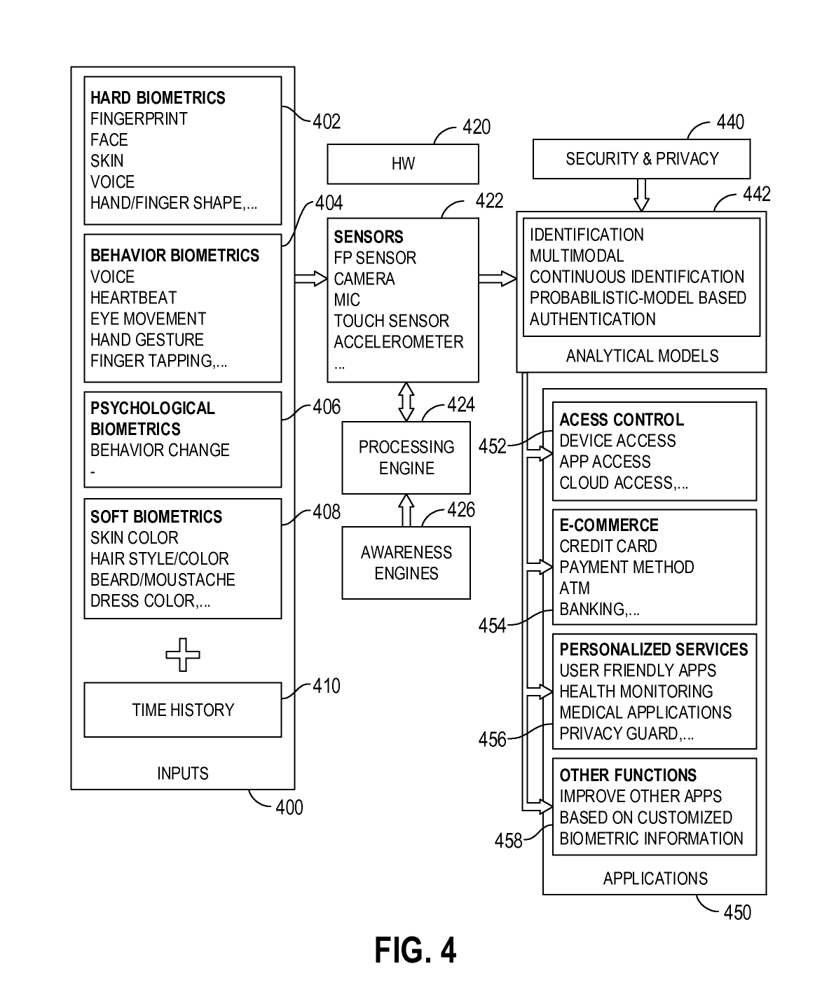

FIG. 4 illustrates a wide variety of different inputs 400 that may be inputted into the hardware 420 of the mobile device to continuously or quasi-continuously update the trust coefficient. For example, as shown in FIG. 4, a variety of hard biological biometrics 402 may be utilized as biometric sensor inputs with appropriate biometric sensors 422 of hardware 420. Examples of hard biological biometrics may include a fingerprint scan, palm print, facial scan, skin scan, voice scan, hand/finger shape imaging, etc. Further, FIG. 4 illustrates that a wide variety of soft biometrics 408 may be utilized as biometric sensor inputs with appropriate biometric sensors 422 of hardware 420, such as skin color, hair style/color, beard/mustache, dress color, etc. Furthermore, various behavior biometrics 404 and psychological biometrics 406 may be determined from sensor inputs with appropriate sensors 422 of hardware 420. Examples of these sensor inputs may include voice inflections, heartbeat variations, rapid eye movements, various hand gestures, finger tapping, behavior changes, etc. Further, as previously described, time history 410 may also be utilized as an input. These types of biometrics may be determined, registered, recorded, etc., in association with appropriate sensors 422 of the hardware 420 of the mobile device for generating trust coefficients, as previously described. Such sensors include biometric sensors and non-biometric sensors, as previously described. Examples of these sensors 422 include all of the previously described sensors, such as a fingerprint sensor, camera sensor, microphone, touch sensor, accelerometer, etc.

Further, the hardware 420 may include one or more processing engines 424 and awareness engines 426 to implement analytical models 442 that may analyze the input from the variety of sensors in order to perform continuous or quasi-continuous authentication of the user. These analytical models 442 may take into account security and privacy settings (e.g., predefined security/privacy preference settings). As examples, types of analytical models 422 utilized may include identification models, multimodal models, continuous identification models, probabilistic-based authentication models, etc.

These analytical models may be utilized for continuous authentication by the generation of trust coefficients for use with external sites, authenticating entities, applications or other users with which the user of the mobile device wishes to interact with. Examples of these types of application 450 interactions may include access control 452 (e.g., device access, application access, cloud access, etc.), e-commerce 454 (e.g., credit card transactions, payment methods, ATM, banking, etc.), personalized services 546 (e.g., user-friendly applications, personal health monitoring, medical applications, privacy guards, etc.), or other functions 458 (e.g., improvement of other applications based on customized biometric information, etc.).

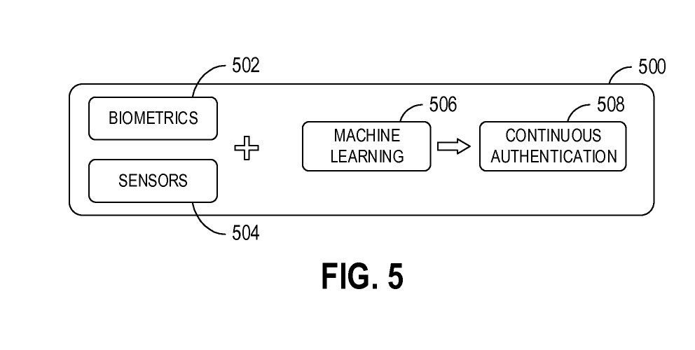

With additional reference to FIG. 5, it should be appreciated that the mobile device may implement a system 500 that allows biometrics 502 of a variety of types (e.g. biological, behavioral, physical, hard, soft, etc.) to be combined with or derived from sensor data 504 including location, time history, etc., all of which may be collected and processed to perform strong authentication via a trust coefficient for continuous authentication. These types of measurements may be recorded and utilized for one or more machine learning processes 506. Based upon this collection of data, the continuous authentication process 508 may be utilized, as previously described. In particular, as a result of the collected data, various features may be provided, such as continuous authentication of the user, better utilization of existing sensors and context awareness capabilities of the mobile device, improved accuracy in the usability of biometrics, and improved security for interaction with service providers, applications, devices and other users.

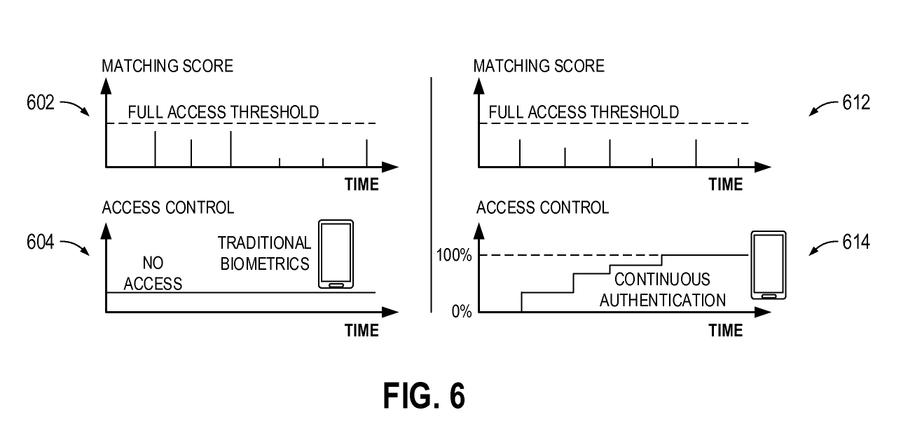

An example of a mobile device utilizing the previously described functionality for continuous authentication with a trust coefficient will be hereinafter described, with reference to FIG. 6. For example, a conventional system that provides authentication when a matching score passes a full access threshold, as shown by graph 602, typically uses only one biometric input (e.g. a fingerprint sensor) for a one-time authentication, and each access is independently processed every time. In the conventional approach, as shown with reference to graph 604, if the one-time authentication (e.g. fingerprint sensor) is not achieved (e.g. the full access threshold not being passed), then no access occurs. On the other hand, utilizing a continuous authentication system, authentication may be continuously and actively performed, and biometrical information may be adaptively updated and changed. Thus, as shown in graph 612, various access controls may be continuously collected and updated, and, as shown in graph 614, based upon this continuous updating for continuous authentication (e.g. first a fingerprint scan, next a facial scan from a camera, next a GPS update, etc.), access control can reach 100% and access will be authenticated. Further, historic information can be collected to improve recognition accuracy.

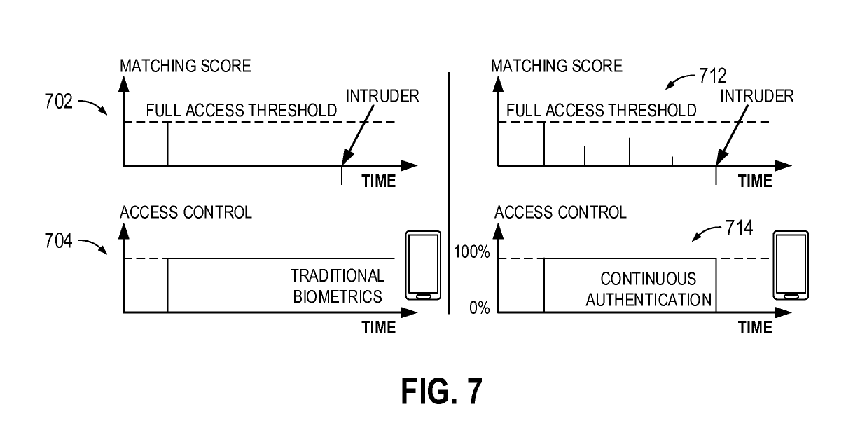

With reference to FIG. 7, detection of intruders may be improved by utilizing a continuous authentication system. Utilizing conventional biometrics, once the full access threshold is met (graph 702), access control is granted (graph 704) and use by a subsequent intruder may not be identified. On the other hand, by utilizing continuous authentication data (graph 712), inputs may be continuously collected (e.g. GPS location, touch screen finger scan, etc.), and even through access control is met (graph 714) and access is granted, an intruder may still be detected. For example, an intruder designation may be detected (e.g., an unknown GPS location), access control will drop and access will be denied, until a stronger authentication input is requested and received by the mobile device, such as a fingerprint scan.

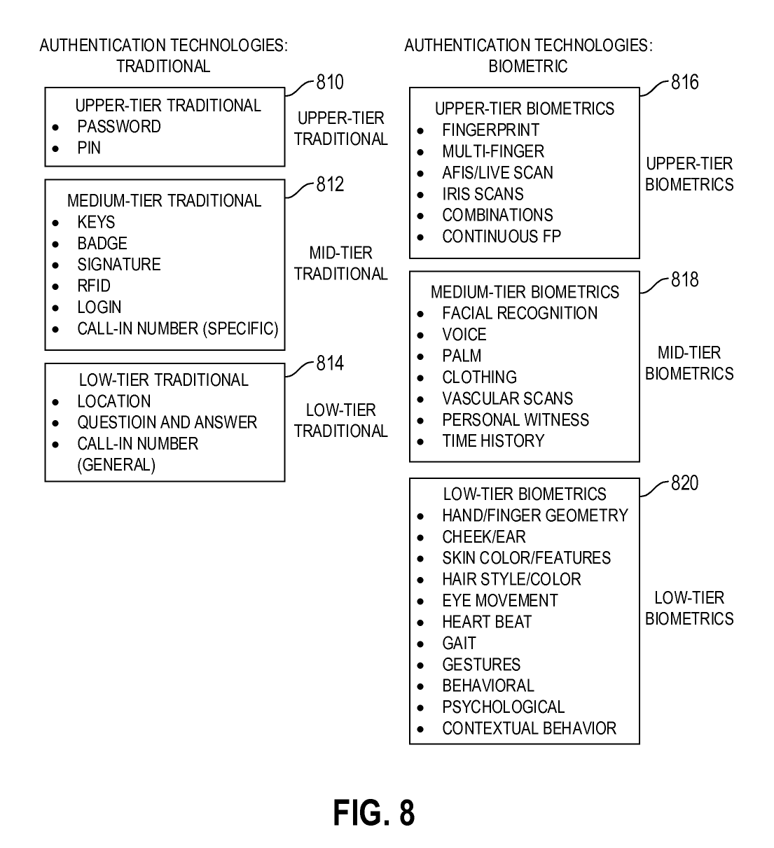

With additional reference to FIG. 8, it should be appreciated that a wide variety of traditional and additional authentication technologies may be utilized. For example, for traditional authentication technologies, a wide variety of types may be utilized. For example, as shown in block 810, upper-tier traditional authentication technologies may include username, password, PIN, etc. Medium-tier traditional authentication technologies shown in block 812 may include keys, badge readers, signature pads, RFID tags, logins, predetermined call-in numbers, etc. Further, as shown in block 814, low-tier traditional authentication technologies may include location determinations (e.g., at a work location), questions and answers (e.g., Turing test), general call-in numbers, etc. It should be appreciated that the previously described mobile device utilizing continuous authentication to continuously update a trust coefficient may utilize these traditional technologies, as well as the additional authentication technologies to be hereinafter described.

Further, embodiments of the invention related to continuous authentication may include a wide variety of additional biometric authentication technologies. For example, as shown in block 816, upper-tier biometric authentication technologies may include fingerprint scanners, multi-fingerprint scanners, automatic fingerprint identification systems (AFIS) that use live scans, iris scans, continuous fingerprint imaging, various combinations, etc. Further, medium-tier biometric authentication technologies may include facial recognition, voice recognition, palm scans, vascular scans, personal witness, time history, etc. Moreover, as shown in block 820, lower-tier biometric authentication technologies may include hand/finger geometry, cheek/ear scans, skin color or features, hair color or style, eye movements, heart rate analysis, gait determination, gesture detection, behavioral attributes, psychological conditions, contextual behavior, etc. It should be appreciated that these are just examples of biometrics that may be utilized for continuous authentication.

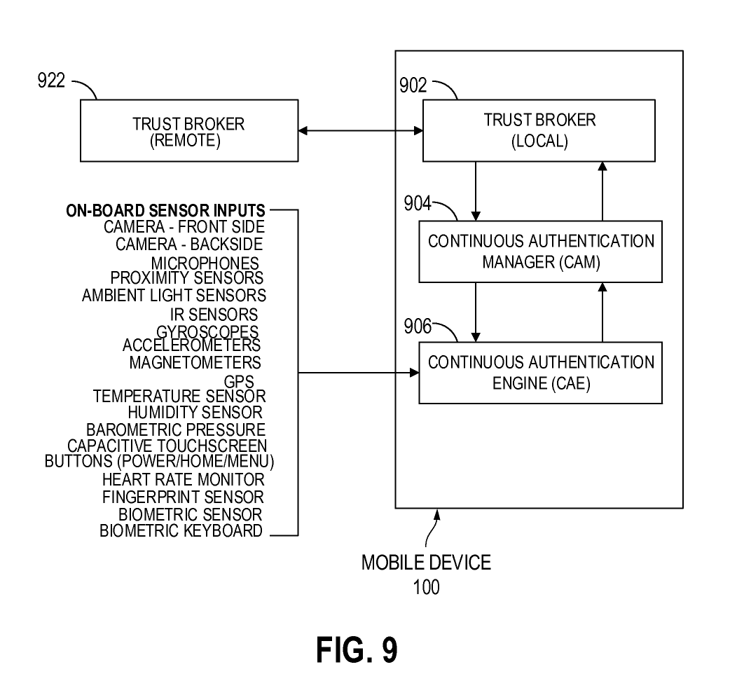

With additional reference to FIG. 9, as previously described, a trust coefficient (TC) may convey the current level of authentication of a user of a mobile device 100. As will be described in more detail hereinafter, mobile device 100 and/or authenticating entity 250 may determine the trust coefficient. As will be described, in some embodiments, a continuous authentication engine (CAE), a continuous authentication manager (CAM), and a trust broker (TB) may be configured to dynamically calculate, in real time, a trust coefficient so as to provide continuous or quasi-continuous authentication capability in mobile devices. Further, the term trust coefficient (TC) may be included as a component of a trust vector (TV). The TV may include a composition of one or more data inputs, sensor information, or scores. In particular, each of the TV inputs may be given authentication strengths and/or scores. Additionally, in some embodiments, the mobile device 100 may include a local trust broker (TB) 902 and the authenticating entity 250 may include a remote trust broker (TB) 922. In some embodiments, local TB 902 may transmit a privacy vector (PV) to the authenticating entity 250 that includes predefined user security preferences such as types of user approved biometric sensor information, non-biometric sensor data, and/or user data input that the user approves of. Similarly, remote TB 922 of the authenticating entity 250 may transmit a privacy vector (PV) to the mobile device 100 that includes predefined security preferences such as types of biometric sensor information, non-biometric sensor data, and/or user data input that the authenticating entity approves of. These types of privacy vectors and trust vectors will be described in more detail hereinafter. In particular, local TB 902 of the mobile device may negotiate with the remote TB 922 of the authenticating entity 250 to determine a trust vector TV that incorporates or satisfies the predefined user security preferences, as well as the predefined security preferences of the authenticating entity 250, such that a suitable TV that incorporates or satisfies the authentication requirements of the authenticating entity 250 and the mobile device 100 may be transmitted to the authenticating entity 250 to authenticate mobile device 100.

In one embodiment, mobile device 100 may include a continuous authentication engine 906 that is coupled to a continuous authentication manager 904, both of which are coupled to the local TB 902. With this implementation, the local TB 902 may communicate with the remote TB 922 of the authenticating entity 250. As one example, the continuous authentication manager 904 may consolidate on-device authentication functions such as interaction with the continuous authentication engine 906, and may interact with application program interfaces (APIs) on the mobile device 100 for authentication-related functions. In some implementations, the local TB 902 may be configured to maintain user security/privacy preferences that are used to filter the data offered by the local TB 902 in external authentication interactions with the remote TB 922 of the authenticating entity 250.

As one example, local TB 902 may interact with the remote TB 922, manage user credentials (e.g. user names, PINs, digital certificates, etc.), determine what types of credentials or information (e.g., user data input, sensor data, biometric sensor information, etc.) are to be released to the remote TB 922 of the authenticating entity (e.g., based on privacy vector information and negotiations with the remote TB 922), assemble and send trust and privacy vectors (TVs and PVs), manage user security/privacy settings and preferences, and/or interface with the continuous authentication manager 904.

In one embodiment, the continuous authentication manager 904 may perform functions including interacting with the local TB 902, controlling how and when trust scores for the trust vectors (TVs) are calculated, requesting specific information from the continuous authentication engine 906 when needed (e.g., as requested by the local trust broker 902), providing output to APIs of the mobile device 101 (e.g., device-level trust controls, keyboard locks, unauthorized use, etc.), and/or managing continuous authentication engine 906 (e.g., issuing instructions to or requesting actions from the continuous authentication engine to update trust scores and/or check sensor integrity when trust scores fall below a threshold value, etc.). In some implementations, the local trust broker 902 may determine, in cooperation with the continuous authentication manager 904 and the continuous authentication engine 906, one or more sensor data, biometric sensor information, data input, sensor data scores, biometric sensor information scores, data input scores, trust coefficients, trust scores, credentials, authentication coefficients, authentication scores, authentication levels, authentication system outputs, or authentication information for inclusion in the trust vector.

In one embodiment, the continuous authentication engine 906 may perform one or more functions including responding to the continuous authentication manager 904; generating trust vector (TV) components; calculating TV scores, values or levels; providing raw data, template data or model data when requested; generating or conveying conventional authenticators (e.g., face, iris, fingerprint, ear, voice, multimodal biometrics, etc.), times/dates, hard biometric authenticators, soft biometric authenticators, hard geophysical authenticators, or soft geophysical authenticators; and accounting for trust-level decay parameters. Hard biometric authenticators may include largely unique identifiers of an individual such as fingerprints, facial features, iris scans, retinal scans or voiceprints, whereas soft biometric authenticators may include less unique factors such as persisting behavioral and contextual aspects, regular behavior patterns, face position with respect to a camera on a mobile device, gait analysis, or liveness. Thus, in one embodiment, the continuous authentication engine 906 may calculate TV scores based upon TV components that are based upon data inputs from one or more non-biometric sensors, biometric sensors, user data input from a user interface, or other authentication information as previously described. As previously described, there is a wide variety of different types of sensors that may provide this type of sensor data such as one or more cameras (front side and/or backside), microphones, proximity sensors, light sensors, IR sensors, gyroscopes, accelerometers, magnetometers, GPS, temperature sensors, humidity sensors, barometric pressure sensors, capacitive touch screens, buttons (power/home/menu), heart rate monitors, ECG sensors, fingerprint sensors, biometric sensors, biometric keyboards, etc. A wide variety of these different types of sensors has been described in detail previously, and are well known to those skilled in the art.

Further, it should be appreciated that by utilizing the continuous authentication manager 904 and the continuous authentication engine 906 in cooperation with local TB 902, local TB 902 may periodically, continuously or quasi-continuously update one or more components of the TV in the authentication response to the remote TB 922 of the authenticating entity to allow for continuous authentication of the mobile device 100 with the authenticating entity.

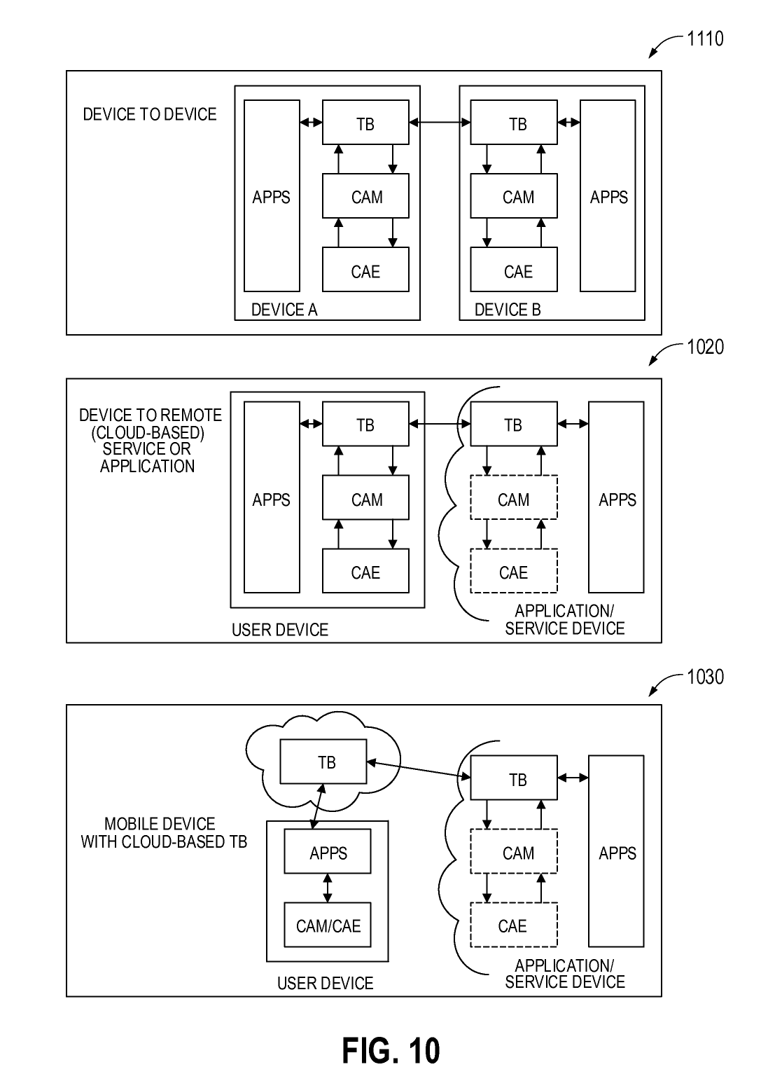

With additional reference to FIG. 10, a variety of different implementations of the trust broker may be configured to support one or more of the following types of trust-broker interactions. For example, with reference to trust-broker interaction 1110, each device (e.g., Device A—mobile and Device B—authenticating entity such as another mobile device, e.g., peer-to-peer) may include a trust broker that interacts with a continuous authentication manager (CAM) and a continuous authentication engine (CAE) on each device. In another example, a trust-broker interaction 1020 conveys an interaction between a user device and a remote (cloud-based) service or application. Both sides include a trust broker; the continuous authentication manager function and the continuous authentication engine function are enabled on the user device side, but are optional on the service/application device side. The continuous authentication engine and continuous authentication manager may be used on the application/service device side to configure the remote trust broker or to provide the ability for the user device to authenticate the application/service device. In yet another example, a cloud-based trust-broker interaction 1030 may be utilized. In this example, the trust broker associated with a mobile device may be located partially or completely away from the mobile device, such as on a remote server. The trust-broker interaction with the continuous authentication manager and/or continuous authentication engine of the user device may be maintained over a secure interface. The continuous authentication manager function and the continuous authentication engine function may be optional on the application/service device side.

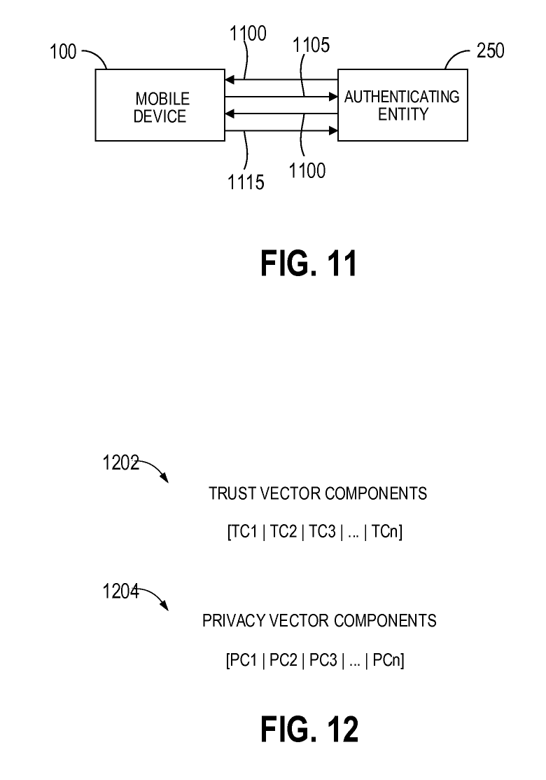

With additional reference to FIG. 11, in one embodiment, local trust broker (TB) 902 of mobile device 100 may be configured to exchange one or more privacy vectors (PVs) and trust vectors (TVs) with authenticating entity 250 for authentication purposes. The PVs and TVs may be multi-field messages used to communicate credentials, authentication methods, user security/privacy preferences, information or data. In particular, the TV may comprise a multi-field data message including sensor data scores, biometric sensor information scores, user data input, or authentication information to match or satisfy the authentication request from the authenticating entity 250. The PVs may be used to communicate the availability of authentication information and/or to request the availability of authentication information. The TVs may be used to request or deliver specific authentication data, information and credentials. The TV may include one or more trust scores, trust coefficients, aggregated trust coefficients, authentication system output, or authentication information.

For example, as can be seen in FIG. 11, authenticating entity 250 may initiate a first PV request 1100 to mobile device 100. The PV request 1100 may include a request for authentication and additional data (e.g., authentication credentials, authentication methods, authentication data requests, etc.). This may include specific types of sensor data, biometric sensor information, user input data requests, user interface data, or authentication information requests. The PV request 1100 may occur after an authentication request has been received by the mobile device 100 from the authenticating entity 250. Alternatively, an authentication request may be included with the PV request 1100. Next, mobile device 100 may submit a PV response 1105 to the authenticating entity 250. This may include the offer or availability of user authentication resources and additional data (e.g. authentication credentials, authentication methods, authentication data, user information, user credentials, or authentication information). Again these are the types of sensor data, biometric sensor information, user data input, or authentication information that match or satisfy predefined user security/privacy preferences and/or settings. Based upon this, the authenticating entity 250 may submit a TV request 1110 to the mobile device 100. The TV request 1110 may request authentication credentials, data requests (e.g. sensor data, biometric sensor information, user data input, etc.), and supply authentication parameters (e.g. methods, persistence, etc.). In response, mobile device 100 may submit a TV response 1115. The TV response 1115 may include authentication credentials, requested data (e.g. sensor data, biometric sensor information, user data input, one or more trust coefficients, authentication information, etc.), and authentication parameters (e.g. methods, persistence, etc.). It should be appreciated that the trust broker of the mobile device 100 may negotiate with the trust broker of the authenticating entity 250 to determine a TV response 1115 that incorporates or satisfies both the predefined user security/privacy preferences and the authentication requirements of the authenticating entity via this back and forth of PVs and TVs. Authentication parameters may include, for example, parameters provided by the authenticating entity that describe or otherwise determine which sensor inputs to acquire information from and how to combine the available sensor information. In some implementations, the authenticating parameters may include a scoring method and a scoring range required by the authenticating entity, how to calculate a particular trust score, how often to locally update the trust score, and/or how often to provide the updated trust score to the authenticating entity. A persistence parameter may include, for example, a number indicating the number of seconds or minutes in which a user is authenticated until an updated authentication operation is required. The persistence parameter may be, for example, a time constant in which the trust coefficient or trust score decays over time. The persistence parameter may be dynamic, in that the numerical value may change with time, with changes in location or behavior of the user, or with the type of content requested.

Thus, in one embodiment, the local trust broker 902 of the mobile device 100 may determine if the PV request 1100 matches, incorporates, or satisfies predefined user security/privacy preferences and if so, the trust broker may retrieve, extract or otherwise receive the sensor data from the sensor, the biometric sensor information from the biometric sensor, the user data input, and/or authentication information that matches or satisfies the PV request 1100. The mobile device 100 may then transmit the TV 1115 to the authenticating entity 250 for authentication with the authenticating entity. However, if the PV request 1100 does not match or otherwise not satisfy the predefined user security/privacy preferences, the local trust broker may transmit a PV response 1105 to the authenticating entity 250 including predefined user security/privacy preferences having types of user-approved sensor data, biometric sensor information, user data input and/or authentication information. The authenticating entity 250 may then submit a new negotiated TV request 1110 that matches or satisfies the request of the mobile device 100. In this way, the trust broker of the mobile device 100 may negotiate with the trust broker of the authenticating entity 250 to determine a TV that matches or satisfies the predefined user security/privacy preferences and that matches or satisfies the authentication requirements of the authenticating entity 250. In this way the PV and TV requests and responses may be used to exchange authentication requirements as well as other data.

In some examples, the PV is descriptive, for example, it may include examples of the form: “this is the type of information I want”, or “this is the type of information I am willing to provide”. Thus, the PV may be used to negotiate authentication methods before actual authentication credentials are requested and exchanged. On the other hand, the TV may be used to actually transfer data and may include statements of the form: “send me this information, using these methods” or “this is the information requested”. In some examples, the TV and PV can be multi-parameter messages in the same format. For example, a value in a field in a PV may be used to indicate a request for or availability of a specific piece of authentication information. The same corresponding field in a TV may be used to transfer that data. As another example, a value of a field of the PV may be used to indicate availability of a particular sensor on a mobile device such as a fingerprint sensor, and a corresponding field in the TV may be used to transfer information about that sensor such as raw sensor data, sensor information, a trust score, a successful authentication result, or authentication information. In some examples, the TV may be used to transfer data in several categories as requested by the PV, for example 1) credentials that may be used to authenticate, e.g., user name, password, fingerprint matching score, or certificate; 2) ancillary authentication data such as specific authentication methods or an updated trust coefficient; 3) optional data such as location, contextual information, or other sensor data and sensor information that may be used in authentication, such as a liveness score or an anti-spoof score; and/or 4) parameters used to control the continuous authentication engine, such as sensor preferences, persistence, time constants, time periods, etc. In some examples, requests and responses may be at different levels and not always include individual identification (e.g., “is this a real human?”, “is this device stolen?”, “is this user X?”, or “who is this user?”). According to some examples, various entities that may request authentication may each have their own respective, flexible authentication schemes, but the trust broker in negotiation using PVs and TVs allows the use of user security and privacy settings to negotiate data offered before the data is transmitted.

With additional reference to FIG. 12, examples of TV components 1202 and PV components 1204 will be described. In particular, a better understanding of the aforementioned features of the PVs and the TVs, according to some examples, may be seen with reference to FIG. 12. For example, various TV components 1202 may be utilized. In this example, TV components 1202: TC1; TC2; TC3 . . . TCn are shown. As examples, these components may form part or all of a multi-field data message. The components may be related to session information, user name, password, time/date stamp, hard biometrics, soft biometrics, hard geophysical location, soft geophysical location, authentication information, etc. These may include user data input, sensor data or information and/or scores from sensor data, as previously described in detail. Additionally, for inbound TVs from the authenticating entity there may be indications as to whether the component is absolutely required, suggested, or not at all required. For example, this may be a value from zero to one. As to outbound TVs from the mobile device to the authenticating entity, sensor fields may be included to indicate whether the specific sensors are present or not present (e.g. one or zero) as well as sensor data, sensor information, scoring levels, or scoring values. Such scoring values may be pass or not pass (e.g. one or zero) or they may relate to an actual score value (e.g. 0-100 or 0-255). Therefore, in some embodiments, the TV may contain specific authentication requests, sensor information or data, or other authentication information.

Further, the PV components 1204 (e.g., PV components 1204: PC1; PC2; PC3 . . . PCn) may describe the request for the availability of authentication devices or authentication information, and indicate permission (or denial) of the request to provide data or information associated with each device. For example, for inbound PVs from an authenticating entity to a mobile device, various fields may include required fields (e.g., 0 or 1), pass/fail (e.g., 0 or 1), values, level requirements, etc. For example, for outbound PVs from the mobile device to the authenticating entity, the fields may include available fields (e.g., 0 or 1), preferences, user-approved preferences or settings that can be provided (e.g., 0 or 1), enumeration of levels that can be provided, etc.

According to some examples, the TV may include a wide variety of different types of indicia of user identification/authentication. Examples of these may include session ID, user name, password, date stamp, time stamp, trust coefficients or trust scores based upon sensor device input from the previously described sensors, fingerprint template information, template information from multiple fingerprints, fingerprint matching score(s), face recognition, voice recognition, face location, behavior aspects, liveness, GPS location, visual location, relative voice location, audio location, relative visual location, altitude, at home or office, on travel or away, etc. Accordingly, these types of TV types may include session information, conventional authorization techniques, time/date, scoring of sensor inputs, hard biometrics, soft biometrics, hard geophysical information, soft geophysical information, etc. In some implementations, visual location may include input from a still or video camera associated with the mobile device, which may be used to determine the precise location or general location of the user, such as in a home office or out walking in a park. Hard geophysical information may include GPS information or video information that clearly identifies the physical location of the user. Soft geophysical information may include the relative position of a user with respect to a camera or microphone, general location information such as at an airport or a mall, altitude information, or other geophysical information that may fail to uniquely identify where a user is located.

It should be appreciated that a wide variety of TV components may be utilized with a wide variety of different types of sensor inputs and the TV components may include the scoring of those TV components. Additional examples may include one or more TV components associated with sensor output information for iris, retina, palm, skin features, cheek, ear, vascular structure, hairstyle, hair color, eye movement, gait, behavior, psychological responses, contextual behavior, clothing, answers to questions, signatures, PINs, keys, badge information, RFID tag information, NFC tag information, phone numbers, personal witness, and time history attributes, for example.

It should be appreciated that many of the trust vector components may be available from sensors that are installed on the mobile device, which may be typical or atypical dependent on the mobile device. Some or all of the sensors may have functionality and interfaces unrelated to the trust broker. In any event, an example list of sensors contemplated may include one or more of the previously described cameras, microphones, proximity sensors, IR sensors, gyroscopes, accelerometers, magnetometers, GPS or other geolocation sensors, barometric pressure sensors, capacitive touch screens, buttons (power/home/menu), heart rate monitor, fingerprint sensor or other biometric sensors (stand alone or integrated with a mouse, keypad, touch screen or buttons). It should be appreciated that any type of sensor may be utilized with aspects of the invention.

It should be appreciated that the local trust broker 902 of the mobile device 100 utilizing the various types of TVs and PVs may provide a wide variety of different functions. For example, the local trust broker may provide various responses to authentication requests from the authenticating entity 250. These various responses may be at various levels and may not always include individual identifications. For example, some identifications may be for liveness or general user profile. As to other functions, the local trust broker may be utilized to manage user credentials and manage authentication privacy. For example, functions controlled by the trust broker may include storing keys and credentials for specific authentication schemes, providing APIs to change user security/privacy settings in response to user security and privacy preferences, providing an appropriate response based on user security/privacy settings, interacting with a CAM/CAE, interacting with an authentication system, or not revealing personal identities or information to unknown requests. Local trust broker functionality may also provide responses in the desired format. For example, the TV may provide a user name/password or digital certificate in the desired format. The local trust broker functionality may also include managing the way a current trust coefficient value affects the device. For example, if the trust coefficient value becomes too low, the local trust value may lock or limit accessibility to the mobile device until proper authentication by a user is received. Trust broker functionality may include requesting the continuous authentication manager to take specific actions to elevate the trust score, such as asking the user to re-input fingerprint information. Furthermore, the trust broker functionality may include integrating with systems that manage personal data. For example, these functions may include controlling the release of personal information or authentication information that may be learned over time by a user profiling engine, or using that data to assist authentication requests. It should be appreciated that the previously described local trust broker 902 of the mobile device 100 may be configured to flexibly manage different types of authentication and private information exchanges. Requests and responses may communicate a variety of authentication-related data that can be generic, user specific, or authentication-method specific.

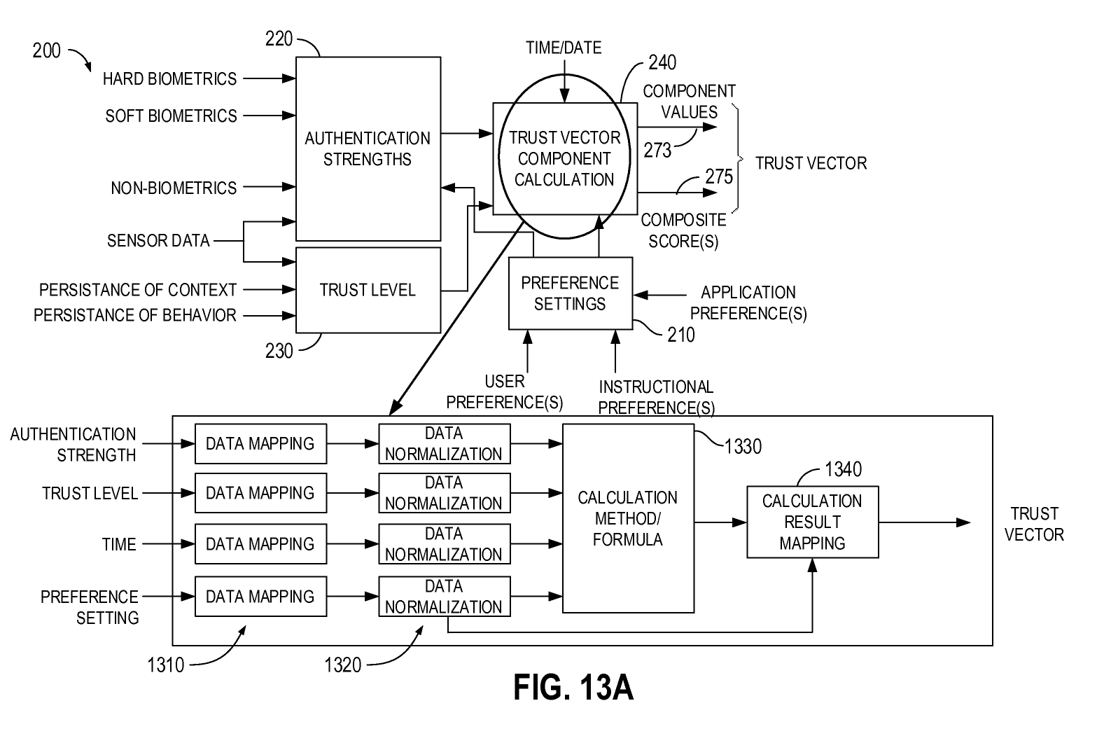

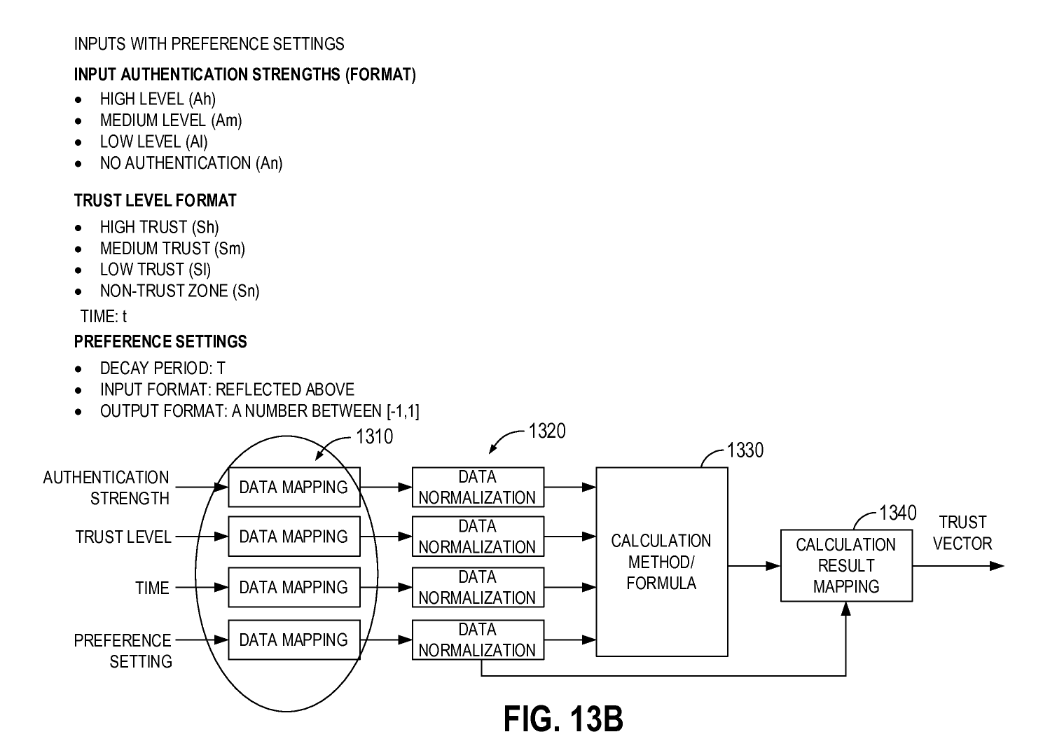

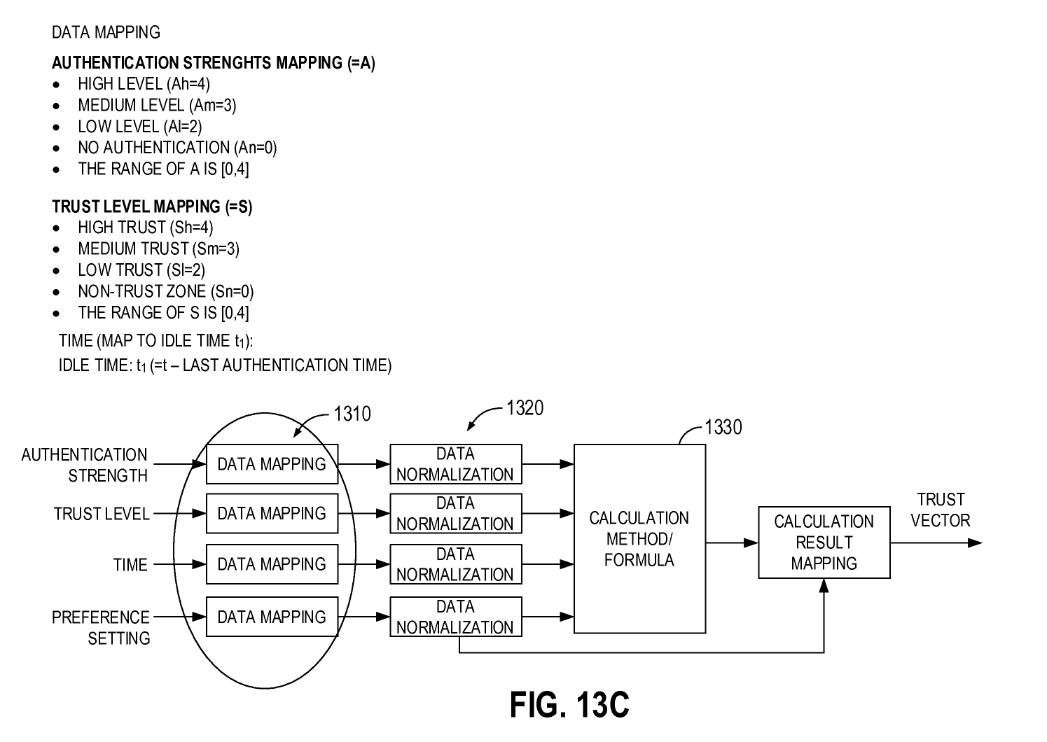

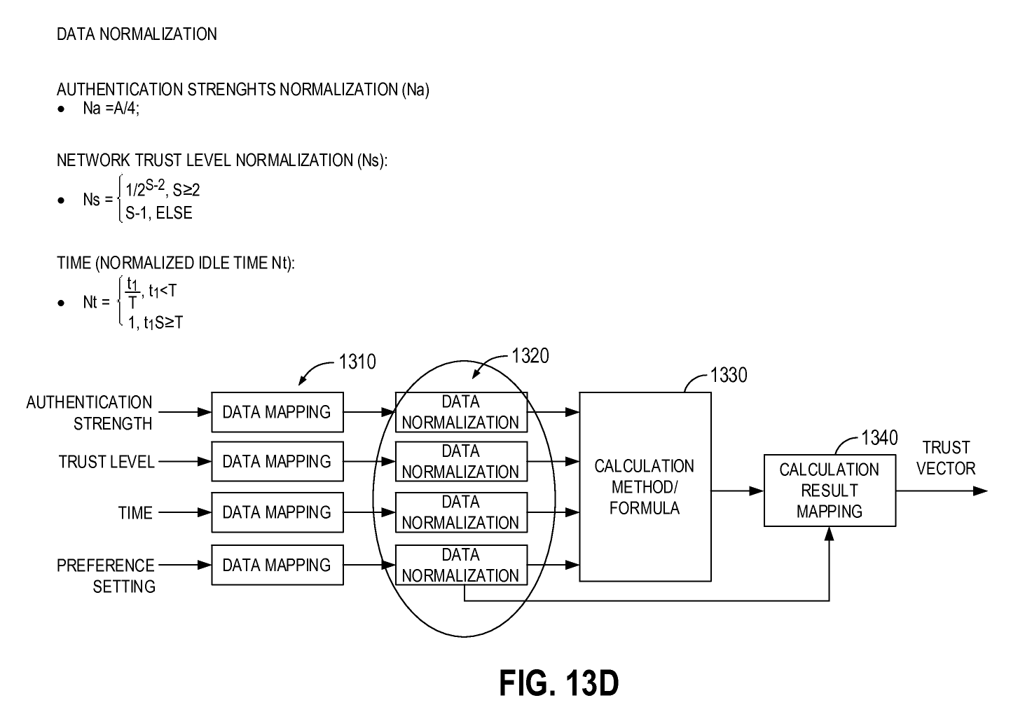

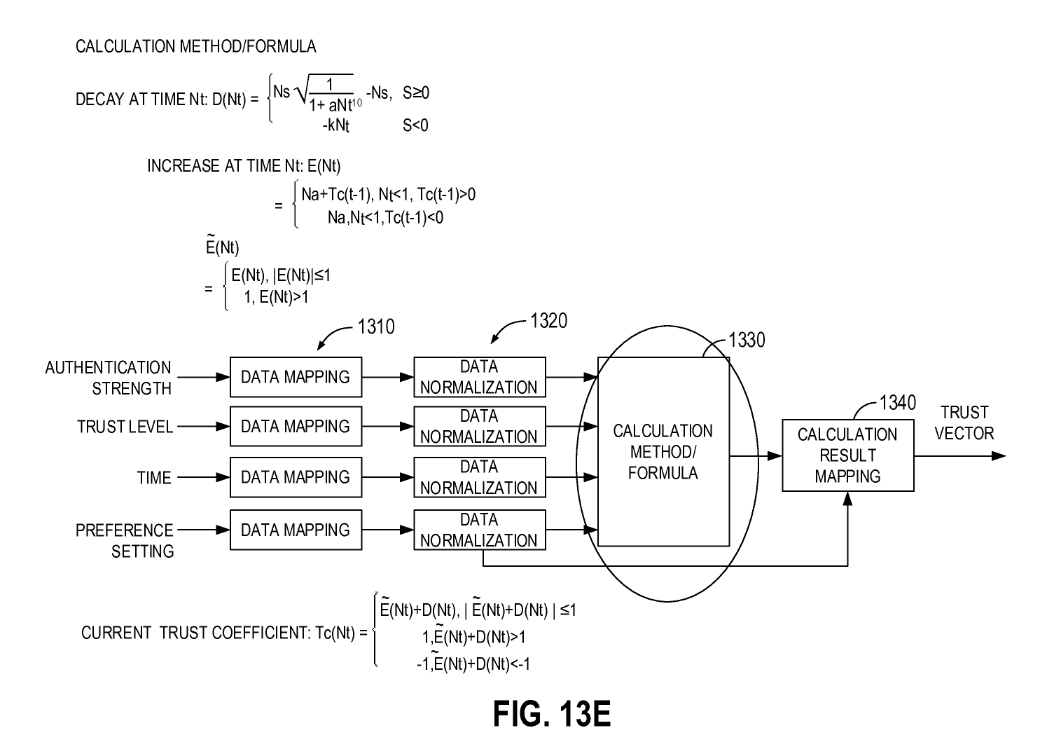

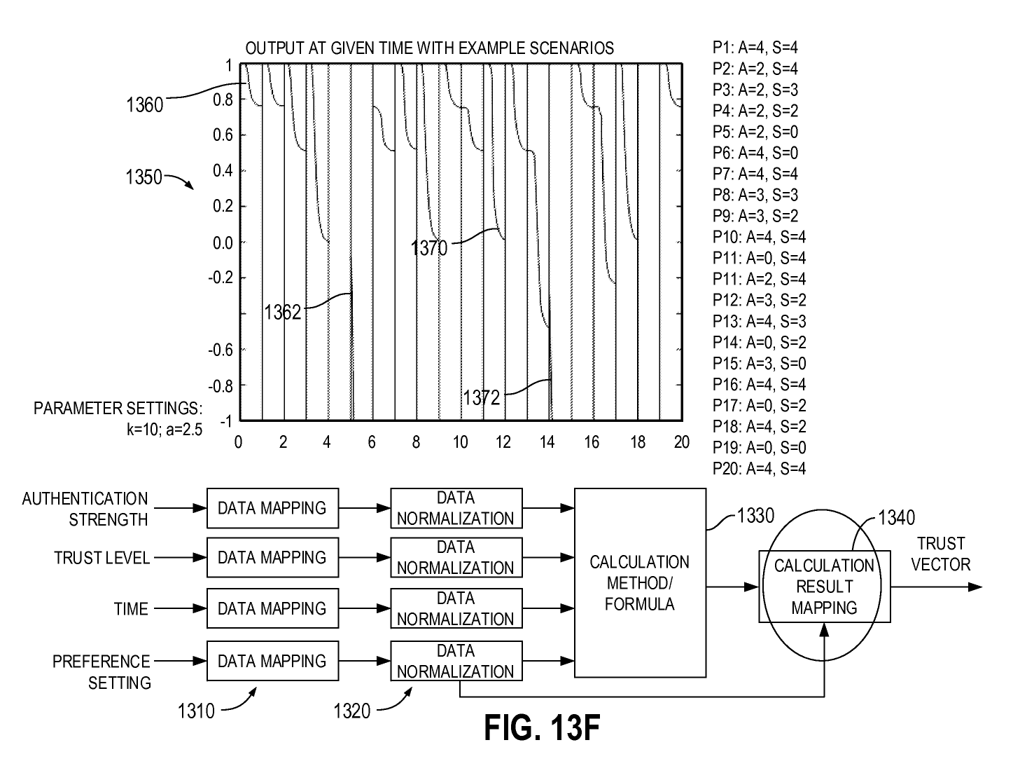

With reference to FIG. 13A, an example of operations of trust vector (TV) component calculation block 240 that may perform TV component calculations will be described. It should be noted that one or more trust coefficients, levels or scores may be included as a component in the trust vector, so that the term TV is used in place of trust coefficient hereinafter. As previously described, inputs from the authentication strength block 220, inputs from preference settings block 210, inputs from trust level block 230, and times/dates may be inputted into the TV component calculation block 240. Based upon the TV component calculation block 240, one or more TV component values 273 and TV composite scores 275 may be outputted to an authenticating entity for continuous authentication. As previously described, based upon the preference setting from preference settings block 210, trust level inputs from trust level block 230, and authentication strength inputs from authentication strength block 220, TV component values 273 and TV component scores 275 may be calculated and transmitted as needed to the authenticating entity. It should be appreciated that the output format of the TV component values 273 and TV component scores 275 may be defined and/or changed from one time to another due to preference setting changes and/or may change from one request to another request due to differences between preference settings of different requestors and/or may change or otherwise be updated based on one or more continuous authentication parameters such as time constant, time delay, sensor data, sensor information, or scoring method. Also, as previously described, the preference settings block 210 may implement a negotiation function or an arbitration function to negotiate or arbitrate conflicting predefined security/privacy preference settings between the authenticating entity and the mobile device, or to form fused preference settings. In any event, as previously described, TV component values 273 and TV composite scores 275 may be calculated continuously and transmitted as needed to an authenticating entity for continuous, or quasi-continuous, or discrete authentication with the authenticating entity.

It should be appreciated that inputs from the elements of the continuous authentication system 200 including preference settings, authentication strengths, trust levels, and time may be mapped into a required or unified format, such as by the use of a look-up table or other algorithm to output a trust vector (TV) or trust vector components in a desired format. Resulting data may be normalized into a predetermined data range before being presented as inputs to the calculation method, formula or algorithm used by the TV component calculation block 240 to calculate components of the trust vector output including TV component values 273 and TV composite scores 275.

As an example, as shown in FIG. 13A, authentication strengths, trust levels, time and preference settings may be inputted into data mapping blocks 1310 that are further normalized through data normalization blocks 1320, which are then transmitted to the calculation method/formula block 1330 (e.g., for calculating TV values including TV component values 273 and TV composite scores 275) and through calculation result mapping block 1340 for mapping, and the resulting TV including TV component values 273 and TV composite scores 275 are thereby normalized and mapped and outputted.

As to data mapping 1310, data mapping may be based on a preset look-up table to map the inputs of data formats into a unified format. As to data normalization 1320, different kinds of input data may be normalized into a predetermined data range. As to the calculation method 1330 of the TV component calculation block 240, a default calculation formula may be provided, the calculation formula may be changed based on the preference setting changes over time, the calculation formula may be changed based upon preference settings from the mobile device and/or different requestors, etc. As to calculation result mapping 1340, the calculated results for the TV including TV component values 273 and TV composite scores 275 may mapped to predetermined preference setting data formats.

With reference to FIGS. 13B-D, examples of data mapping and data normalization for the formatting, mapping, and normalizing of authentication system inputs will be hereinafter described. For example, authentication strengths may be mapped into a format that represents level strengths of high, medium, low, or zero (no authentication capability) [e.g., Ah, Am, Al and An]. Trust levels may be mapped into a format representing high, medium, low or zero (non-trusted level) [e.g., Sh, Sm, Sl and Sn]. There may a time level of t. Preference setting formats may also be used to provide inputs relating to a trust decay period (e.g., a value between −1 and 1). These values may be mapped to values over a defined range and utilized with time data including data representing time periods between authentication inputs. Example of these ranged values may be seen with particular reference to FIG. 13C. Further, with additional reference to FIG. 13D, after going through data mapping 1310, these data values may also be normalized by data normalization blocks 1320. As shown in FIG. 13D, various equations are shown that may be used for the normalization of authentication strengths, trust levels and time. It should be appreciated that these equations are merely for illustrative purposes.

The previously described data, after mapping and normalizing, may be used to form or otherwise update a trust vector (TV) (including TV component values 273 and TV composite scores 275). The TV may vary according to the inputs (e.g., authentication strengths, trust levels, time and/or preference settings) and may vary over time between authentication events. With reference to FIG. 13E, FIG. 13E shows an example of a calculation formula to be used by calculation formula block 1330 for generating an example trust vector or trust coefficient in response to the various authentication system inputs. As shown in the example equation of FIG. 13E, these authentication inputs may include normalized time, normalized trust levels, normalized authentication strengths, etc. It should be appreciated that these equations are merely for illustrative purposes.

FIG. 13F includes a graphical representation of an example trust vector (TV) that has been calculated by calculation formula block 1330 and mapped/normalized by calculation mapping block 1340 such that the TV has a value varying between 1 (high trust) and −1 (high mistrust) [y-axis] over time [x-axis] and illustrates how the trust vector may change in discrete amounts in response to specific authentication inputs (e.g., such as recovering to a high trust level after the input and identification of an authentication fingerprint). Between authentication events, the TV may vary, such as decaying according to time constant parameters that are provided. Inputs may trigger discrete steps in values lowering the trust value (e.g., such as the user connecting from an un-trusted location) or may trigger a rapid switch to a level representing mistrust, such as an event that indicates the device may be stolen (e.g., several attempts to enter a fingerprint that cannot be verified and the mobile device being at an un-trusted location).

For example looking at the graph 1350, period P1 line 1360 may indicate a high authentication strength A=4 (e.g., authenticated fingerprint and camera iris scan match) and a high trust level format S=4 (e.g., known location via GPS), and, as shown by line 1360, slightly decays over time. As another example, with reference to line 1362 in period P5 in which the authentication strength A=2 (e.g., medium level such as a gripping via touch sensors) and the trust level equals zero S=0 (e.g., an un-trusted location), line 1362 shows that the trust level decays very quickly to a negative trust level (e.g., −1). As another example, line 1370 in period P11 indicates that the input authentication strength may be very low (A=0), but the trust level remains high (e.g. S=4), such that requested authentication input may not have been received but the mobile device is in a known location via GPS. Based upon this scenario, the trust level 1370 declines over time to zero (e.g. diminished trust but not yet negative). On the other hand, continuing with this example, as later shown at P14 line 1372, with no authentication or wrong authentication (e.g. an iris scan that is not suitable, a fingerprint scan that is not verifiable, etc.) and a decreased medium trust level (S=2) (e.g., distance away from the known GPS location), the trust level may go to −1, in which case further authentication is required or no additional action for authentication may be taken.

It should be appreciated that wide variety of trust vectors (TVs) in view of authentication strengths and trust levels over time may be determined in a continuous or quasi-continuous manner for authentication purposes.

In some implementations, the trust broker previously described may be used in conjunction with techniques disclosed in applicant's provisional application entitled “Trust Broker for Authentication Interaction with Mobile Devices”, application No. 61/943,428 filed Feb. 23, 2014, the disclosure of which is hereby incorporated by reference into the present application in its entirety for all purposes.

It should be appreciated that aspects of the invention previously described may be implemented in conjunction with the execution of instructions by one or more processors of the device, as previously described. For example, processors of the mobile device and the authenticating entity may implement the functional blocks previously described and other embodiments, as previously described. Particularly, circuitry of the devices, including but not limited to processors, may operate under the control of a program, routine, or the execution of instructions to execute methods or processes in accordance with embodiments of the invention. For example, such a program may be implemented in firmware or software (e.g. stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

It should be appreciated that when the devices are mobile or wireless devices, they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet computer, a mobile computer, a laptop computer, an entertainment device (e.g., a music or video device), a headset (e.g., headphones, an earpiece, etc.), a medical device (e.g., a biometric sensor, a heart rate monitor, a pedometer, an ECG device, etc.), a user I/O device, a computer, a wired computer, a fixed computer, a desktop computer, a server, a point-of-sale device, a set-top box, or any other suitable device. These devices may have different power and data requirements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal or mobile device. In the alternative, the processor and the storage medium may reside as discrete components in a user terminal or mobile device.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A mobile device comprising:
a set of biometric and non-biometric sensors; and
a processor configured to:
receive sensor data from the set of sensors;
form authentication information from the received sensor data; and
continuously update the authentication information.

2. The mobile device of claim 1, wherein the updated authentication information includes at least one of a trust coefficient, trust level, trust score, authentication coefficient, authentication level, authentication score, or authentication strength.

3. The mobile device of claim 1, wherein the updated authentication information incorporates predefined security and privacy preference settings.

4. The mobile device of claim 1, wherein the updated authentication information satisfies predefined security and privacy preference settings.

5. The mobile device of claim 3, wherein the predefined security and privacy preference settings include types of user-approved sensor data, biometric sensor information, user data input, or authentication information.

6. The mobile device of claim 3, wherein the processor implements a negotiation function to negotiate conflicting predefined security and privacy preference settings of the mobile device and an authenticating entity to form fused security and privacy preference settings.

7. The mobile device of claim 1, wherein the processor implements an authentication strength function to determine an authentication strength for the received sensor data.

8. The mobile device of claim 7, wherein the processor implements a trust level function to analyze persistency over time to determine a trust level associated with the authentication information.

9. The mobile device of claim 8, wherein the processor implements a trust coefficient calculation function to determine a trust coefficient based upon the authentication strength and the trust level.

10. The mobile device of claim 1, wherein the processor is further configured to transmit the updated authentication information to an authenticating entity in response to an authentication request from the authenticating entity.

11. A method to perform continuous authentication comprising:
receiving sensor data from a set of biometric and non-biometric sensors;
forming authentication information from the received sensor data; and
continuously updating the authentication information.

12. The method of claim 11, wherein the updated authentication information includes at least one of a trust coefficient, trust level, trust score, authentication coefficient, authentication level, authentication score, or authentication strength.

13. The method of claim 11, wherein the updated authentication information incorporates predefined security and privacy preference settings.

14. The method of claim 11, wherein the updated authentication information satisfies predefined security and privacy preference settings.

15. The method of claim 13, wherein the predefined security and privacy preference settings include types of user-approved sensor data, biometric sensor information, user data input, or authentication information.

16. The method of claim 13, further comprising negotiating conflicting predefined security and privacy preference settings of the mobile device and an authenticating entity to form fused security and privacy preference settings.

17. The method of claim 11, further comprising determining an authentication strength for the received sensor data.

18. The method of claim 17, further comprising analyzing persistency over time to determine a trust level associated with the authentication information.

19. The method of claim 18, further comprising determining a trust coefficient based upon the authentication strength and the trust level.

20. The method of claim 11, further comprising transmitting the updated authentication information to an authenticating entity in response to an authentication request from the authenticating entity.

21. A non-transitory computer-readable medium including code that, when executed by a processor, causes the processor to:
receive sensor data from a set of biometric and non-biometric sensors;
form authentication information from the received sensor data; and
continuously update the authentication information.

22. The computer-readable medium of claim 21, wherein the updated authentication information includes at least one of a trust coefficient, trust level, trust score, authentication coefficient, authentication level, authentication score, or authentication strength.

23. The computer-readable medium of claim 21, wherein the updated authentication information incorporates predefined security and privacy preference settings.

24. The computer-readable medium of claim 21, wherein the updated authentication information satisfies predefined security and privacy preference settings.

25. The computer-readable medium of claim 23, wherein the predefined security and privacy preference settings include types of user-approved sensor data, biometric sensor information, user data input, or authentication information.

26. The computer-readable medium of claim 23, further comprising code to negotiate conflicting predefined security and privacy preference settings of the mobile device and an authenticating entity to form fused security and privacy preference settings.

27. The computer-readable medium of claim 21, further comprising code to determine an authentication strength for the received sensor data.

28. The computer-readable medium of claim 27, further comprising code to analyze persistency over time to determine a trust level associated with the authentication information.

29. The computer-readable medium of claim 28, further comprising code to determine a trust coefficient based upon the authentication strength and the trust level.

30. A mobile device comprising:
means for receiving sensor data from a set of biometric and non-biometric sensors;
means for forming authentication information from the received sensor data; and
means for continuously updating the authentication information.
